(19) United States
(12) Patent Application Publication
(10) Pub. No.: US 2024/0317351 A1
(43) Pub. Date: Sep. 26, 2024

(54) PART OF A CYCLE FRAME OR OF A CYCLE FORK AND METHOD TO ASSEMBLE SUCH A PART

(71) Applicant: Cowboy S.A., Bruxelles (BE)

(72) Inventor: Vincent Belpaire, Uccle (BE)

(21) Appl. No.: 18/262,498

(22) PCT Filed: Jan. 7, 2022
(86) PCT No.: PCT/EP2022/050235

§ 371 Date: Jul. 21, 2023

(30) Foreign Application Priority Data
Jan. 22, 2021 (EP) 21153031.6

(51) Int. Cl. B62K 19/02; B21D 53/86; B62K 21/02; F16B 17/00

(52) U.S. Cl. CPC B62K 19/02; B21D 53/86; B62K 21/02; F16B 17/004

(57) ABSTRACT

The present disclosure proposes a part of a cycle frame, such as a bicycle frame for example, and also a part of a cycle fork. The part of the cycle frame or of the cycle fork comprises a core (10) and at least two shells (11, 12) that surround the core and are fixed to the core without being fixed directly to each other.

The present disclosure also relates to a method to assemble a cycle frame or a part of a cycle frame or a cycle fork or a part of a cycle fork.

The present disclosure relates to a cycle frame, such as a bicycle frame for example. The present disclosure also relates to a fork of a cycle, such as the fork of a bicycle for example. The present disclosure also concerns a method to assemble a cycle frame or a cycle fork or part of a cycle frame or of a cycle fork.

### CONTEXT OF THE DISCLOSURE

Cycle frames and cycle forks, such as bicycle frames or bicycle forks for example, are known to be composed of an assembly of welded metal tubes or of tubes in composite materials. The assembly of such frames or forks requires however a lot of specialized labor, particularly to weld or glue the tubes together and then grind the joints and/or apply putty on the junction areas or a smooth finish of a composite assembly if one wants to achieve a nicely finished result. Another example is a frame made of two stamped metal shells which are welded together at the periphery.

Another example is a frame made of a one-piece moulded thermoplastic, which would require oversized profile sections and/or wall thickness to fulfil stiffness and strength requirements, resulting to an addition of weight when compared to metal shells.

Recent improvement of the tradeoff between mechanical properties and weight of a cycle frame or of a cycle fork has been achieved thanks to the use of composite structures.

Such improved cycle frames are for example known from American patent application US2014191492, which discloses a bicycle frame made of two half-shells which are directly attached to each other to form a frame or frame component.

Although such cycle frames constitute an improvement over frames composed of welded metal tubes or of tubes in composite materials because of the reduced number of components to be assembled, there is still room for improvement in terms of weight and mechanical properties of the frame and/or of the fork, and also in terms of tradeoff between the manufacturing cost, the number of components to be assembled and the mechanical properties and weight of the frame.

A similar cycle frame is known from Austrian patent application AT514406, but this design does not provide enough strength to the assembly, unless the elements forming the frame are welded together, which in turn presents the above disadvantages in terms of finishing and specialized labour costs.

A similar cycle frame is also known from German patent application DE19640955, but this assembly is complex to manufacture and offers also very limited design freedom to integrate further components. It may also suffer from insufficient strength or from excessive weight.

### SUMMARY OF THE DISCLOSURE

It is an object of the present disclosure to address the need for an enhanced trade-off between the mechanical properties and the weight of a cycle frame and/or of a cycle fork, yet keeping material and assembly costs low.

A further object of the present disclosure is to provide additional design freedom for component integration without increasing the cost.

According to the present disclosure, there is provided a part of a cycle frame or of a cycle fork, said part having the shape of a tube or of a gutter and comprises a core, a first shell and a second shell surrounding the core. The first shell and the second shell are fixed respectively to opposite lateral sides of the core and the first shell is linked to the second shell exclusively through the core. A first edge of the first shell is facing a first edge of the second shell, and/or a second edge of the first shell is facing a second edge of the second shell. The core is fixed to only a first portion of an inner surface of the first shell, and the core is fixed to only a second portion of an inner surface of the second shell.

By the term “cycle”, one understands a wheeled vehicle moved at least partially be human power, such as a unicycle, a bicycle, a tricycle, a push-scooter, and the like.

“Wherein the first shell is linked to the second shell exclusively through the core” means that the first shell is not fixed directly to the second shell such as for example by welding, gluing, bolting or riveting all or parts of the first and second shells together.

Indeed, making a part of a cycle frame or of a fork from three different components instead of from a single component or from two components increases the number of degrees of freedom at designer's disposal to enhance the trade-off between the mechanical properties and the weight of a cycle frame. The supplementary degrees of freedom can also be used to simplify the manufacturing process of a part of a cycle frame or of a fork. Moreover, with a reduced attachment surface between the shells and the core, the core can be designed in more different ways, for example to optimise the weight and/or to reduce the manufacturing complexity and/or to integrate further components.

In some embodiments, the first shell is not in contact with the second shell, whether in direct contact or indirectly true a glue applied directly between the first shell and the second shell.

In some embodiments, the said first portion of the inner surface of the first shell is located at or around a longitudinal border of the first shell and the said second portion of the inner surface of the second shell is located at or around a longitudinal border of the second shell.

Indeed, such locations for the attachment points of the shells to the core enhance the mechanical transmission to the second shell of a mechanical constraint occurring on the first shell and vice versa.

In some embodiments, a volume comprised between the inner surface of the first shell and the inner surface of the second shell is only partially filled by the core. Indeed, such a free volume allows to save weight and/or can be exploited to store other components or as passageways for other components such as cables for example.

In some embodiments, the core comprises a longitudinal trough hole. Indeed, such a free space running along the core can be used to accommodate other parts such as electrical or brake cables for instance.

In some embodiments, a cross-section of the core is continuous. A continuous section means a section made as a single piece, as opposed to an assembly of several parts. Indeed, a core with a continuous cross-section reduces the number of assembly steps. It also seamlessly transfers the constraints that occur on its external surface to the whole core.

In some embodiments, the core is made of a first material, the first shell is made of a second material, different from the first material, and the second shell is made of the second material or made of a third material different from the first material and different from the second material.

Indeed, using different materials increases the number of degrees of freedom at designer's disposal to enhance the trade-off between the mechanical properties and the weight of a cycle frame. The supplementary degrees of freedom can also be used to simplify the manufacturing process of a part of a cycle frame or of a fork.

It has to be noted that, according to the present disclosure, two materials made of the same chemical components are considered different from one another if the one has an internal structure different from the other, such a different internal structure possibly resulting from a different production process (e.g. aluminum can be produced in different ways to provide different mechanical properties) or from a different mixture, in quantity or structure, of the chemical components, one of these chemical components possibly being absent from the mixture.

In some embodiments, the first material is a plastic material, preferably a thermoplastic material, preferably with natural, glass or carbon fibers reinforcement, and the second material is an organosheet or a metal, preferably aluminium, steel or magnesium, and the third material is an organosheet or a metal, preferably aluminium, steel or magnesium.

In some embodiments, the first shell and the second shell are glued and/or welded to the core. Indeed, such attachment techniques leave the outer (visible) surface of the part of a cycle frame or of a cycle fork unaltered, which presents advantages in terms of safety for the user and which may also be aesthetically desirable. Moreover, the manufacturing process does not have to include additional steps to achieve a similar effect, which would have been required by surface-altering techniques.

In case the part of the cycle frame or of the cycle fork has the shape of a tube, the core has In some embodiments the shape of an “I” or of a “Z” or of an “X” or of a “Y” or of an “O”. In such a case the core is In some embodiments fixed to the inner surface of the first shell and to the inner surface of the second shell, respectively through the two distal extremities of the “I” or of the “Z” or through the four distal extremities of the “X” or through the three distal extremities of the “Y”. Indeed, such a core transfers the constraints occurring on one spot of the part of the cycle frame or cycle fork efficiently and contributes to improve its rigidity.

In case the part of the cycle frame or of the cycle fork has the shape of a gutter, the first edge of the first shell is facing the first edge of the second shell at an apex of the gutter. In such a case the core has In some embodiments the shape of a tuning fork and is fixed to the inner surface of the first shell and to the inner surface of the second shell through the top portions of its tines and through its base.

Indeed, such a core transfers the constraints occurring on one spot of the part of the cycle frame or cycle fork efficiently and contributes to improve its rigidity.

According to the present disclosure, there is also provided a method to assemble a cycle frame or a cycle fork, comprising the steps of:
a. providing a plurality of individual core parts equipped at their distal portions with adjustable connection means,
b. connecting the individual core parts together and adjusting their relative positions until a core of pre-defined dimensions is formed,
c. providing a first shell,
d. providing a second shell,
e. fixing the first shell by its inner surface to a first lateral side of the core,
f. fixing the second shell by its inner surface to a second lateral side that is opposite to the first lateral side of the core, and
g. refraining from fixing the first shell directly to the second shell.

Indeed, with such a method it is possible to design the shells with a view to covering whatever part of the core one likes. In particular, if the core is made of several individual parts connected to one another, one can design the shells to cover (and so hide) the connected portions of the individual core parts. This is advantageous regarding common frame assembly methods, as assembly of metal tubes, which require a costly post-treatment of a frame's external surface if one wishes to achieve smooth, safe and aesthetic external surfaces of a frame or of a fork of a frame. Indeed, welding of metal tubes requires a sanding operation afterwards if one wants to have a clean smooth finish of the external surfaces of the tubes.

### SHORT DESCRIPTION OF THE DRAWINGS

These and further aspects of the present disclosure will be explained in greater detail by way of examples and with reference to the accompanying drawings in which:

FIG. 1 shows a 3D cross section of an example of a part of a cycle frame or of a cycle fork according to the present disclosure;

FIG. 2 shows a 3D cross section of an example of a part of a cycle frame or of a cycle fork according to a preferred embodiment;

FIG. 3a shows a 3D cross section of an example of a part of a cycle frame or of a cycle fork according to a preferred embodiment;

FIG. 3b shows a 3D cross section of an example of a part of a cycle frame or of a cycle fork according to a more preferred embodiment;

FIG. 3c shows a 3D cross section of an example of a part of a cycle frame or of a cycle fork according to a preferred embodiment;

FIG. 3d shows a 3D cross section of an example of a part of a cycle frame or of a cycle fork according to a preferred embodiment;

FIG. 3e shows a 3D cross section of an example of a part of a cycle frame or of a cycle fork according to a preferred embodiment;

FIG. 3f shows a 3D cross section of an example of a part of a cycle frame or of a cycle fork according to a preferred embodiment;

FIG. 4a shows a 3D cross section of an example of a part of a cycle frame or of a cycle fork according to a preferred embodiment;

FIG. 4b shows a 3D cross section of an example of a part of a cycle frame or of a cycle fork according to a preferred embodiment;

FIG. 5a shows a 3D cross section of an example of a part of a cycle frame or of a cycle fork according to a preferred embodiment;

FIG. 5b shows a 3D cross section of an example of a part of a cycle frame or of a cycle fork according to a preferred embodiment;

FIG. 6a shows a 3D cross section of an example of a part of a cycle frame or of a cycle fork according to a preferred embodiment;

FIG. 6b shows a 3D cross section of an example of a part of a cycle frame or of a cycle fork according to a preferred embodiment;

FIG. 7a shows a lateral view of an example of a core of a part of a cycle frame according to a preferred embodiment and while being assembled;

FIG. 7b shows the core of FIG. 7a after assembly;

FIG. 8 shows an example of a connection means between two individual core parts of a part of a cycle frame or of a cycle fork according to the present disclosure;

FIG. 9a shows a 3D view of an example of a part of a cycle frame according to the present disclosure when assembled;

FIG. 9b shows an exploded view of the part of a cycle frame of FIG. 9a;

FIG. 10a shows a 3D view of an example of a cycle fork according to the present disclosure when assembled;

FIG. 10b shows an exploded view of the cycle fork of FIG. 10a.

The drawings of the figures are neither drawn to scale nor proportioned. Generally, similar or identical components are denoted by the same reference numerals in the figures.

### DESCRIPTION OF EMBODIMENTS

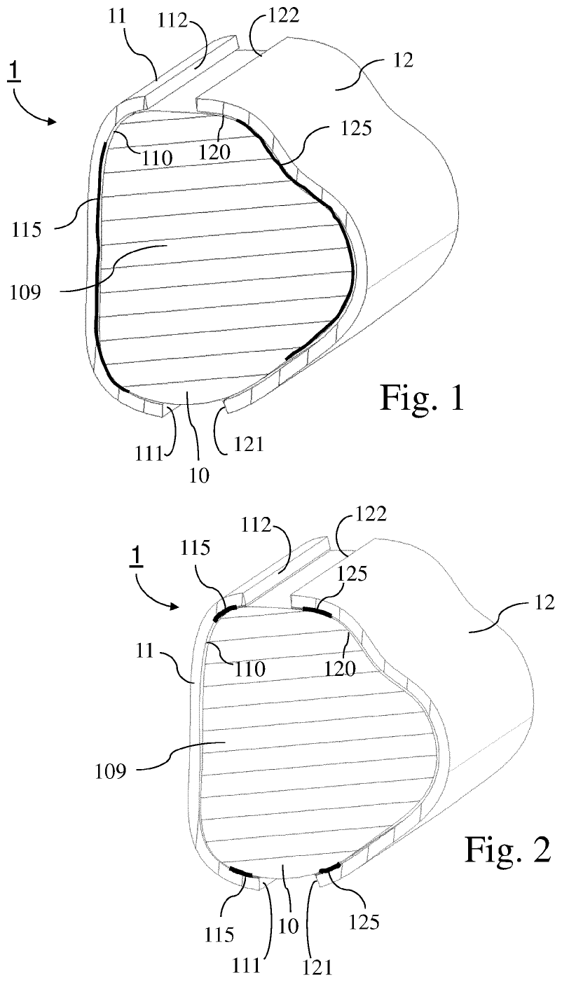

FIG. 1 shows a 3D cross section of an example of a part (1) of a cycle frame or of a cycle fork according to the present disclosure. It comprises a core (10), a first shell (11) and a second shell (12). The first shell (11) and the second shell (12) are fixed to two opposite lateral sides of the core (10) respectively. The two shells (11, 12) are linked to each other exclusively through the core (10).

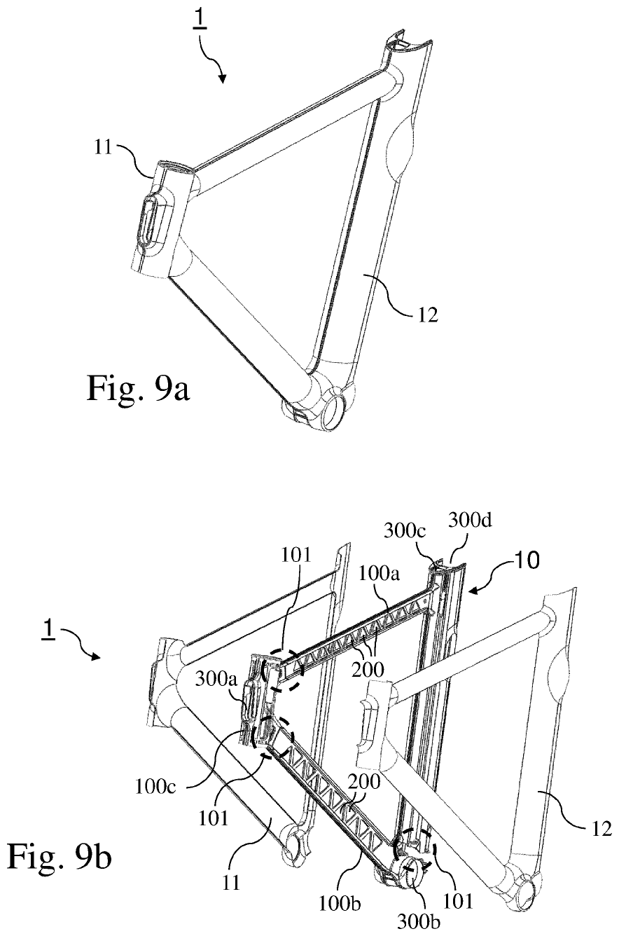

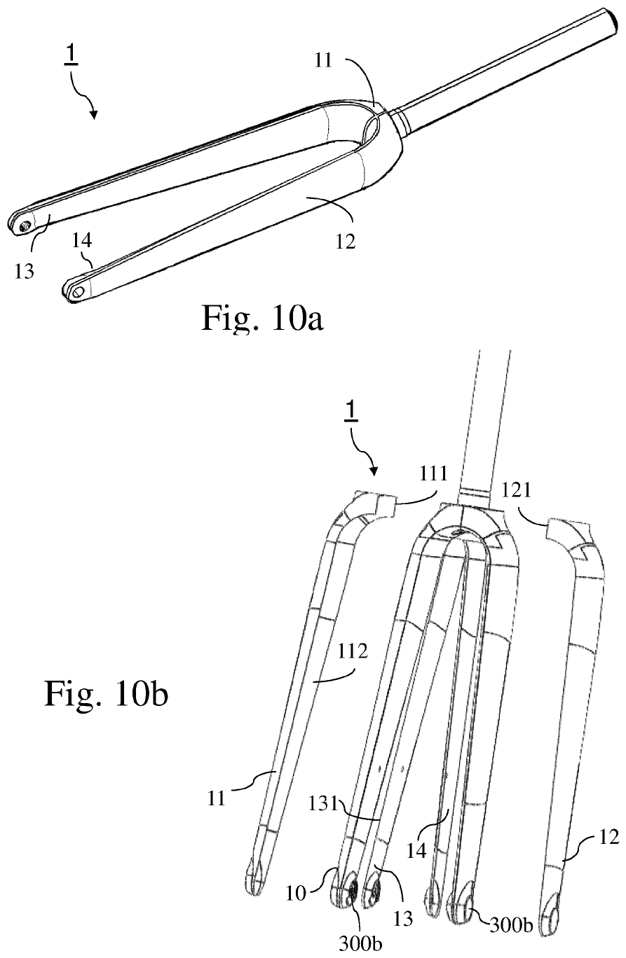

The two shells (11, 12) may be in contact or not in contact with each other, provided the first shell is not fixed directly to the second shell such as for example by welding, gluing, bolting or riveting all or parts of the first and second shells together. Preferably, and as shown in the example of FIG. 1 to FIG. 6b as well as on FIG. 9a to FIG. 10b, the two shells (11, 12) are not in contact with each other.

A first edge (111) of the first shell (11) is facing a first edge (121) of the second shell (12), and/or a second edge (112) of the first shell (11) is facing a second edge (122) of the second shell (12). The first edge (111) of the first shell (11) does not necessarily need to be parallel with the first edge (121) of the second shell (12), provided that the first edge (111) of the first shell (11) can “see” the first edge (121) of the second shell (12). The same holds for the second edge (112) of the first shell (11) and for the second edge (122) of the second shell (12).

The core (10) is fixed to only a first portion (115) of an inner surface (110) of the first shell (11), and the core (10) is fixed to only a second portion (125) of an inner surface (120) of the second shell (12).

FIG. 2 shows a 3D cross section of an example of a part of a cycle frame or of a cycle fork according to a preferred embodiment.

In this preferred embodiment the said first portion (115) of the inner surface (110) of the first shell (11) is located at or around a longitudinal border of the first shell (11) and the second said portion (125) of the inner surface (120) of the second shell (12) is located at or around a longitudinal border of the second shell (12). In this preferred embodiment the core (10) is fixed to only the first portion (115) of an inner surface of the first shell (11) and to only the second portion (125) of an inner surface of the second shell (12).

FIG. 2 illustrates the two portions (115, 125) of the inner surfaces of the shells (11, 12) that are made of two separate areas of the inner surfaces. However, those two portions (115, 125) could include one or more separate areas of the inner surfaces. In particular, they could be a different number of areas for each shell (11, 12).

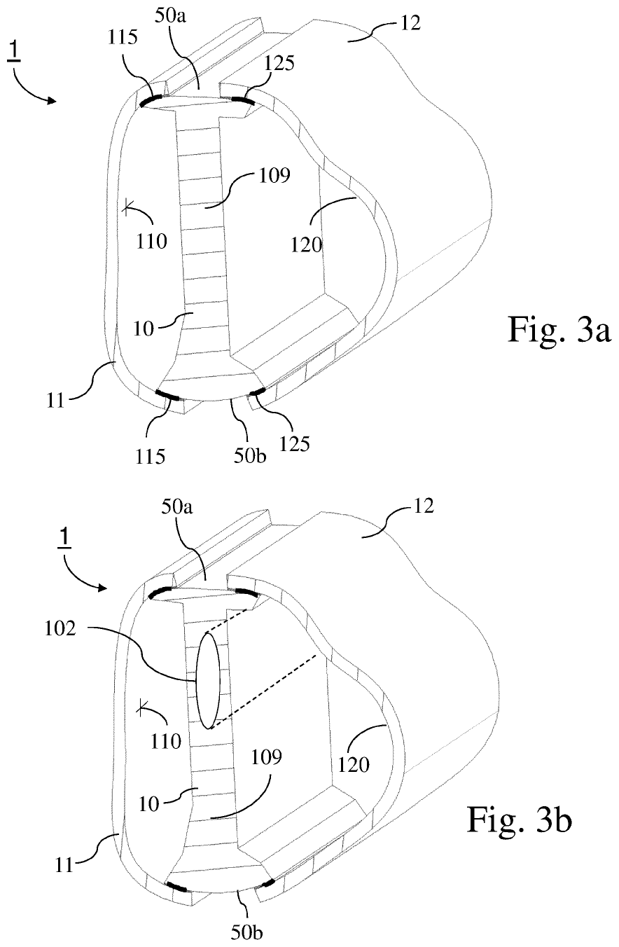

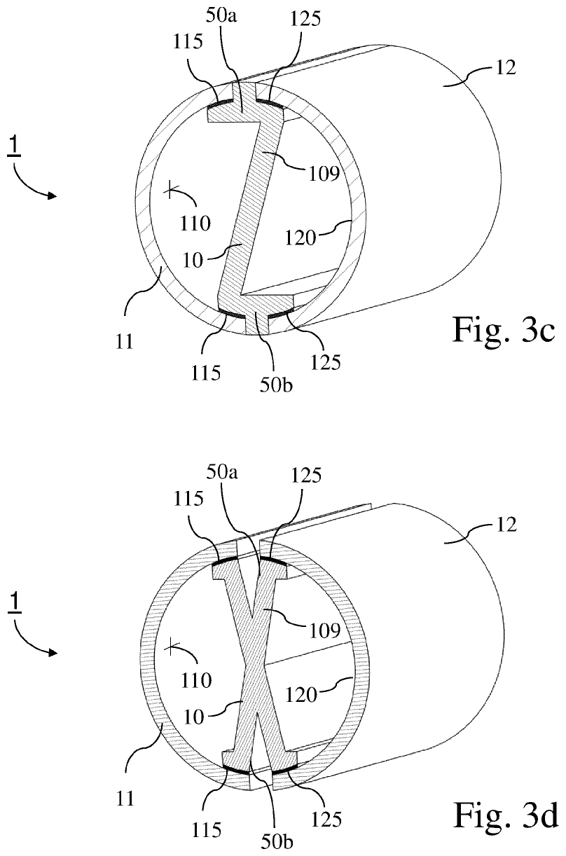

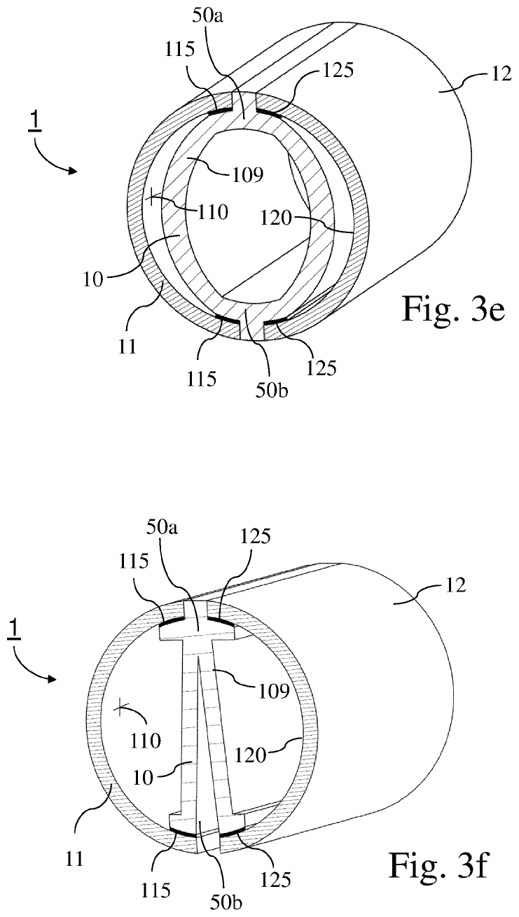

FIG. 3a shows a 3D cross section of an example of a part of a cycle frame or of a cycle fork according to a preferred embodiment.

In this preferred embodiment, a volume comprised between an inner surface (110) of the first shell (11) and an inner surface (120) of the second shell (12) is only partially filled by the core (10). In this example the core has a shape of an “I” but it may also have other shapes provided it does not fill completely the volume comprised between an inner surface of the first shell and an inner surface of the second shell.

FIG. 3b shows a 3D cross section of an example of a part of a cycle frame or of a cycle fork according to a more preferred embodiment. In this more preferred embodiment, the core (10) comprises at least one longitudinal through hole (102).

FIG. 3c shows a 3D cross section of an example of a part of a cycle frame or of a cycle fork according to a preferred embodiment. In this embodiment, the core (10) has a shape of a “Z” whose distal extremities (50a, 50b) are fixed to the inner surface (110) of the first shell and to the inner surface (120) of the second shell at fixation portions (115, 125).

FIG. 3d shows a 3D cross section of an example of a part of a cycle frame or of a cycle fork according to a preferred embodiment. In this embodiment, the core (10) has a shape of an “X” whose distal extremities (50a, 50b) are fixed to the inner surface (110) of the first shell and to the inner surface (120) of the second shell at fixation portions (115, 125).

FIG. 3e shows a 3D cross section of an example of a part of a cycle frame or of a cycle fork according to a preferred embodiment. In this embodiment, the core (10) has a shape of an “O” whose top and bottom portions (50a, 50b) are fixed to the inner surface (110) of the first shell and to the inner surface (120) of the second shell at fixation portions (115, 125). As shown in this example, there is a gap between the inner surfaces (110, 120) of the shells and the lateral sides of the “O”.

FIG. 3f shows a 3D cross section of an example of a part of a cycle frame or of a cycle fork according to a preferred embodiment. In this embodiment, the core (10) has a shape of an “Y” whose distal extremities (50a, 50b) are fixed to the inner surface (110) of the first shell and to the inner surface (120) of the second shell at fixation portions (115, 125).

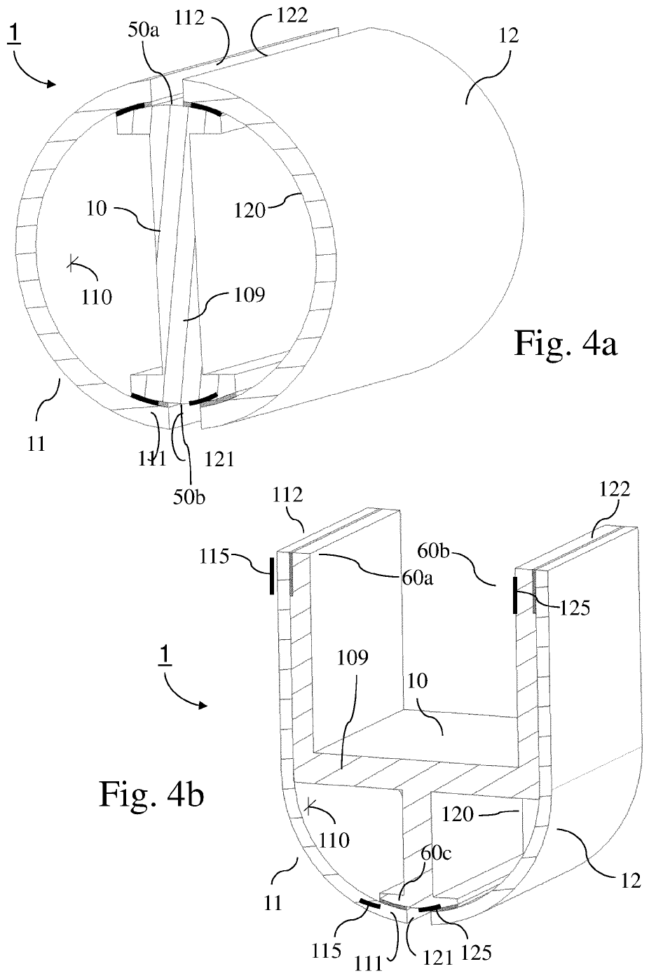

FIG. 4a shows a 3D cross section of an example of a part of a cycle frame or of a cycle fork according to a preferred embodiment.

In this preferred embodiment, the part (1) of a cycle frame of a cycle fork has the shape of a cylindrical tube and the core (10) has the shape of an “I”.

FIG. 4b shows a 3D cross section of an example of a part of a cycle frame or of a cycle fork according to another preferred embodiment. In this preferred embodiment, the part (1) of a cycle frame of a cycle fork has the shape of a gutter. In this preferred embodiment, a first edge (111) of the first shell (11) is facing a first edge (121) of the second shell (12) at an apex of the gutter. Here also, the first edge (111) of the first shell (11) does not necessarily need to be parallel with the first edge (121) of the second shell (12), provided the first edge (111) of the first shell (11) can “see” the first edge (121) of the second shell (12).

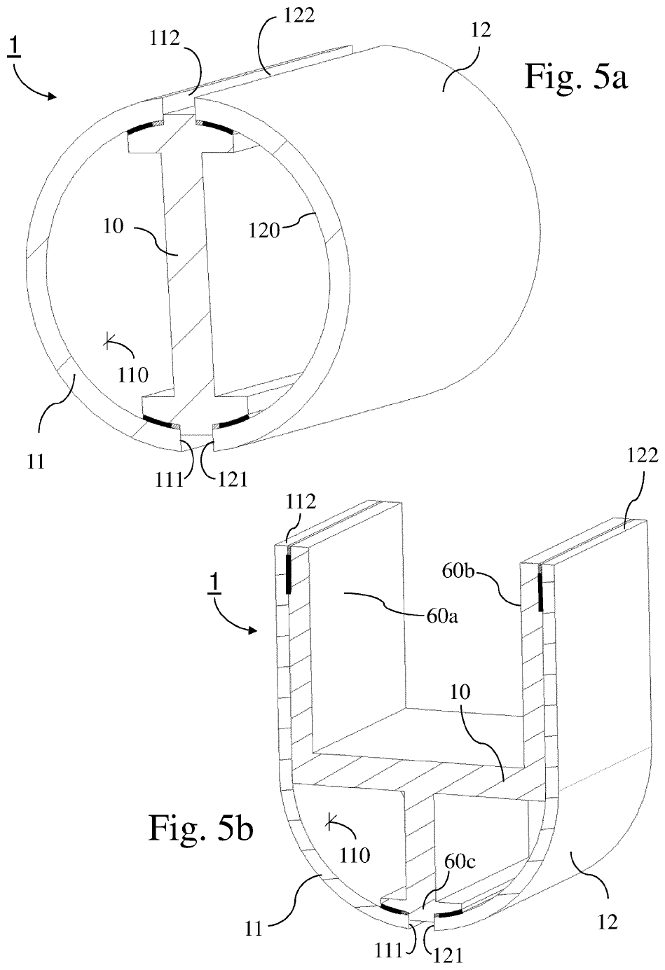

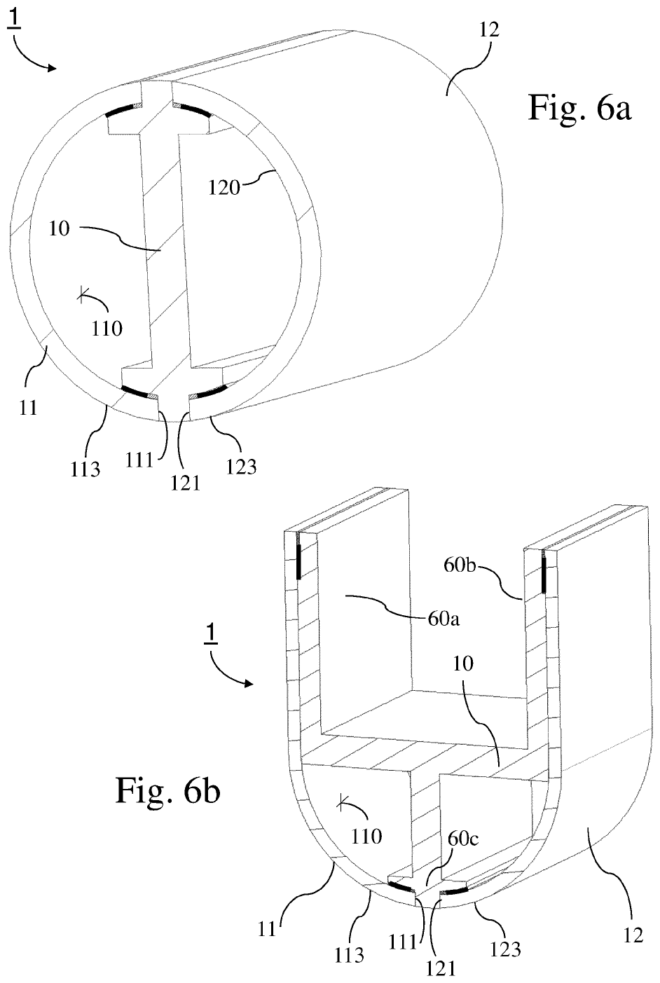

In case the part of the cycle frame or of the cycle fork has the shape of a gutter, and as illustrated on FIG. 4b, FIG. 5b, and FIG. 6b for example, the core (10) has preferably the shape of a tuning fork and is fixed to the inner surface of the first shell and to the inner surface of the second shell only through the top portions (60a, 60b) of its tines and through its base (60c).

FIG. 5a shows a 3D cross section of an example of a part (1) of a cycle frame or of a cycle fork according to a preferred embodiment wherein the said part (1) has the shape of a tube and wherein the core (10) at least partially fills a gap between the first edge (111) of the first shell (11) and the first edge (121) of the second shell (12) and/or wherein the core (10) at least partially fills a gap between the second edge (112) of the first shell (11) and the second edge (122) of the second shell (12).

FIG. 6a shows a 3D cross section of an example of a part (1) of a cycle frame or of a cycle fork according to a preferred embodiment. It is similar to the embodiment of FIG. 5a, except that the core (10) is flush with an outer surface (113) of the first shell (11) and the core (10) is flush with an outer surface (123) of the second shell (12), at the said gap.

It is to be noted that in such embodiment, the tube doesn't necessarily have to be a cylindrical tube, provided it has the general shape of a tube, as shown for example on FIG. 1.

FIG. 5b shows a 3D cross section of an example of a part (1) of a cycle frame or of a cycle fork according to a preferred embodiment wherein the said part (1) has the shape of a gutter and wherein the core (10) at least partially fills a gap between the first edge (111) of the first shell (11) and the first edge (121) of the second shell (12).

FIG. 6b shows a 3D cross section of an example of a part (1) of a cycle frame or of a cycle fork according to a preferred embodiment. It is similar to the embodiment of FIG. 5b, except that the core (10) is flush with an outer surface (113) of the first shell (11) and the core (10) is flush with an outer surface (123) of the second shell (12), at the said gap.

In all embodiments, the core (10) is preferably made of a first material while the first and second shells (11, 12) are both made of a second material, which is different from the first material. More preferably, the core (10) is made of a first material while the first shell (11) is made of a second material, which is different from the first material, and the second shell (12) is made of a third material, which is different from the first material and from the second material.

A first material can be a plastic material, such as a thermoplastic material for example, or a metal, such as aluminium, steel or magnesium for example. A second material can be a metal, such as aluminium, steel or magnesium for example. A second material can also be composite such as organosheets for example. A third material can be a metal, such as aluminium, steel or magnesium for example. A third material can also be composite such as organosheets for example.

Preferably, the first shell (11) and the second shell (12) are glued and/or welded to the core (10), preferably at the previously indicated fixations portions (115, 125).

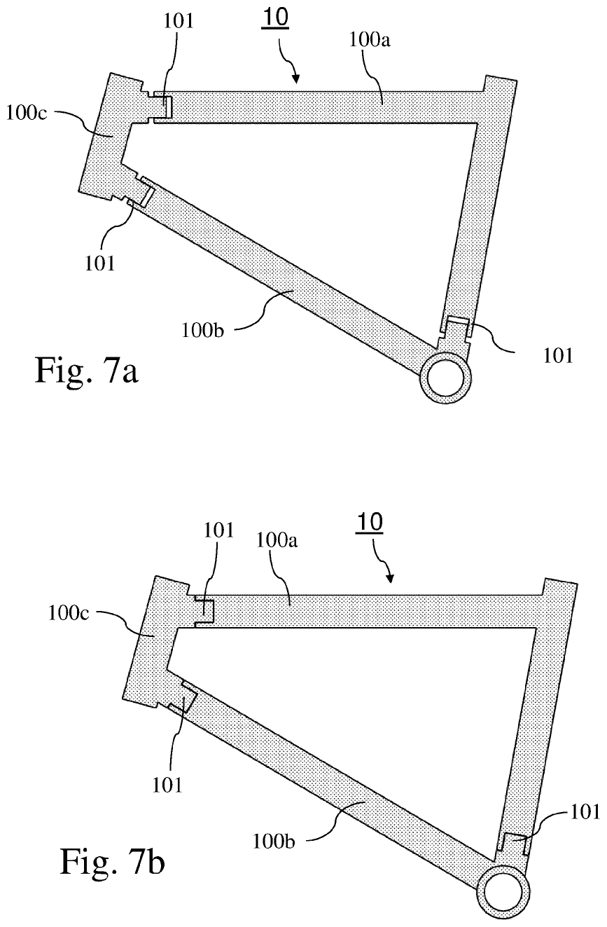

FIG. 7a shows a lateral view of an example of a core of a part (1) of a cycle frame according to a preferred embodiment, while being assembled. In this preferred embodiment, the core (10) comprises a plurality of individual core parts (100a, 100b, 100c) connected one to another at their distal portions (101) by adjustable connection means. In the example of FIG. 7a the core (10) comprises three individual core parts (100) while being assembled, but there may of course be more individual core parts. FIG. 7b shows the core (10) of FIG. 7a, after assembly of the core parts (100a, 100b, 100c).

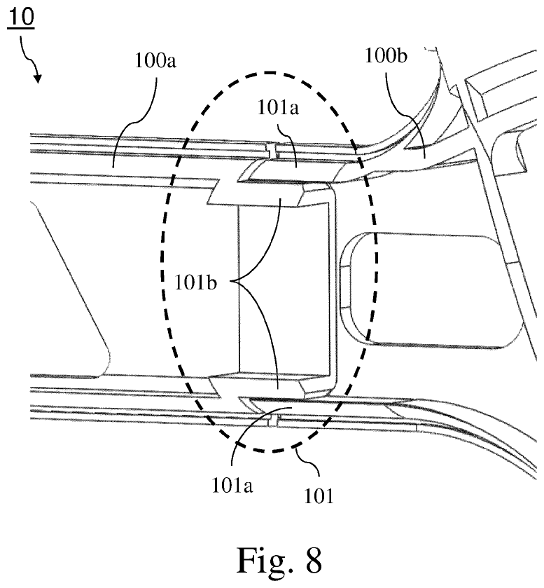

FIG. 8 shows an example of such adjustable connection means that connect two individual core parts (100a, 100b) and/or (100a, 100c) and/or (100b, 100c). In this example, the adjustable connection means comprise two complementary sliding distal portions (101), a first distal portion (101a) on a first individual core part and a second distal portion (101b) on a second individual core part. In the example of FIG. 8, the first distal portion (101a) has an “I” profile and the second distal portion (101b) has a “U” profile, both profiles being preferably configured to allow an axial sliding movement only. Optionally, the two distal portions (101a, 101b) can be glued or welded after assembly. Alternatively, the adjustable connection means could comprise the combination of a pin located on a distal portion of a first individual core part (100a) with a slot larger than the pin located in a distal portion of a second individual core part (100b).

The adjustable connection means may optionally comprise means to attach the two connected individual core parts (100a, 100b) together, such as snap fits, gluing or welding surfaces for example.

FIG. 9a shows a 3D view of an example of a part of a cycle frame according to the present disclosure and FIG. 9b shows an exploded view of the part of a cycle frame of FIG. 9a. On FIG. 9b, one can see the two shells (11, 12) as well as the core (10). In this example, the core (10) comprises three individual core parts (100a, 100b, 100c), assembled to each other as for example illustrated on FIG. 7b.

In this preferred embodiment, the first shell (11) and the second shell (12) cover the said distal portions (101) of the three individual core parts (100a, 100b, 100c).

As shown for example on FIG. 9b, at least some of the individual core parts (100a, 100b, 100c) preferably comprise cut outs (200) to reduce the weight, and/or at least some of the individual core parts (100a, 100b) preferably comprise hollow portions (300a, 300b, 300c, 300d) to later receive respectively a headlight (portion 300a) and/or a bottom bracket (portion 300b) and/or a seat post (portion 300c) and/or a battery (portion 300d).

FIG. 10a shows a 3D view of an example of a cycle fork according to the present disclosure. This example of a fork comprises one core (10) and a first, a second, a third and a fourth shell (11, 12, 13, 14). In this preferred embodiment the core (10) is made of a single part, and a first edge (111) of the first shell (11) is facing a first edge (121) of the second shell (12), and a second edge (112) of the first shell (11) is facing a first edge (131) of the third shell (13). FIG. 10b shows an exploded view of the cycle fork of FIG. 10a.

Preferably, the cycle is a unicycle, a bicycle, a tricycle or a quadricycle.

The present disclosure also concerns a method to assemble a cycle frame or a part of a cycle frame or a cycle fork or a part of a cycle fork, comprising the steps of:
a. providing a plurality of individual core parts (100a, 110b, 100c) equipped at their distal portions with adjustable connection means,
b. connecting the individual core parts (100a, 110b, 100c) together and adjusting their relative positions until a core (10) of pre-defined dimensions is formed,
c. providing a first shell (11),
d. providing a second shell (12),
e. fixing the first shell (11) by its inner surface (110) to a first lateral side of the core (10),
f. fixing the second shell (12) by its inner surface (120) to a second lateral side that is opposite to the first lateral side of the core (10), and
g. refraining from fixing the first shell (11) directly to the second shell (12).

Preferably, the step e) is preceded by the step(s) of having the first shell (11) undergoing a surface treatment and/or having the second shell (12) undergoing a surface treatment.

The present disclosure has been described in terms of specific embodiments, which are illustrative and not to be construed as limiting.

Reference numerals in the claims do not limit their protective scope.

Use of the verbs “to comprise”, “to include”, “to be composed of”, or any other variant, as well as their respective conjugations, does not exclude the presence of elements other than those stated.

Use of the article “a”, “an” or “the” preceding an element does not exclude the presence of a plurality of such elements.

The present disclosure may also be described as follows: a part (1) of a cycle frame, and a part of a cycle fork, the cycle being a bicycle frame for example.

The part of the cycle frame or of the cycle fork comprises a core (10) and at least two shells (11, 12) that surround the core and are fixed to the core without being fixed directly to each other. The present disclosure also relates to a method to assemble a cycle frame or a part of a cycle frame or a cycle fork or a part of a cycle fork.

1-19. (canceled)

20. A part of a cycle frame or of a cycle fork, said part having the shape of a tube or of a gutter and comprises a core, a first shell and a second shell surrounding the core, wherein the first shell and the second shell are fixed respectively to opposite lateral sides of the core and wherein the first shell is linked to the second shell exclusively through the core, wherein a first edge of the first shell is facing a first edge of the second shell and/or wherein a second edge of the first shell is facing a second edge of the second shell, wherein the core is fixed to only a first portion of an inner surface of the first shell, and wherein the core is fixed to only a second portion of an inner surface of the second shell.

21. The part of a cycle frame or of a cycle fork according to claim 20, wherein the said first portion of the inner surface of the first shell is located at or around a longitudinal border of the first shell and wherein the second said portion of the inner surface of the second shell is located at or around a longitudinal border of the second shell.

22. The part of a cycle frame or of a cycle fork according to claim 20, wherein a volume comprised between the inner surface of the first shell and the inner surface of the second shell is only partially filled by the core.

23. The part of a cycle frame or of a cycle fork according to claim 20, wherein the core comprises a longitudinal trough hole.

24. The part of a cycle frame or of a cycle fork according to claim 20, wherein a cross-section of the core is continuous.

25. The part of a cycle frame or of a cycle fork according to claim 20, wherein the said part has the shape of a tube and wherein the core has the shape of an “I” or of a “Z”, or of an “O”, or of an “X”, or of a “Y”.

26. The part of a cycle frame or of a cycle fork according to claim 25, wherein the core is fixed to the inner surface of the first shell and to the inner surface of the second shell respectively through the distal extremities of the “I”, or of the “Z”, or of the “O”, or of the “X”, or of the “Y”.

27. The part of a cycle frame or of a cycle fork according to claim 20, wherein the said part has the shape of a gutter and wherein the first edge of the first shell is facing the first edge of the second shell at an apex of the gutter.

28. The part of a cycle frame or of a cycle fork according to claim 27, wherein the core has the shape of a tuning fork and is fixed to the inner surface of the first shell and to the inner surface of the second shell through the top portions of its tines and through its base.

29. The part of a cycle frame or of a cycle fork according to claim 20, wherein the core at least partially fills a gap between the first edge of the first shell and the first edge of the second shell.

30. The part of a cycle frame or of a cycle fork according to claim 29, wherein the core is flush with an outer surface of the first shell and with an outer surface of the second shell at the said gap.

31. The part of a cycle frame or of a cycle fork according to claim 20, wherein the core is made of a first material, wherein the first shell is made of a second material, different from the first material, and wherein the second shell is made of the second material or made of a third material different from the first material and different from the second material.

32. The part of a cycle frame or of a cycle fork according to claim 31, wherein the first material is a plastic material, preferably a thermoplastic material preferably reinforced with natural, glass or carbon fibres, and wherein the second material is an organosheet or a metal, preferably aluminium, steel or magnesium, and wherein the third material is an organosheet or a metal, preferably aluminium, steel or magnesium.

33. The part of a cycle frame or of a cycle fork according to claim 20, wherein the first shell and the second shell are glued and/or welded to the core.

34. The part of a cycle frame or of a cycle fork according to claim 20, wherein the core comprises a plurality of individual core parts connected one to another at their distal portions by adjustable connection means.

35. The part of a cycle frame or of a cycle fork according to claim 34, wherein the first shell and the second shell cover the said distal portions and adjustable connection means.

36. The part of a cycle frame or of a cycle fork according to claim 20, wherein the cycle is a unicycle, a bicycle, a tricycle or a quadricycle.

37. A method to assemble a cycle frame or a part of a cycle frame or a cycle fork or a part of a cycle fork, comprising the steps of:
a. providing a plurality of individual core parts equipped at their distal portions with adjustable connection means,
b. connecting the individual core parts together and adjusting their relative positions until a core of pre-defined dimensions is formed,
c. providing a first shell,
d. providing a second shell,
e. fixing the first shell by its inner surface to a first lateral side of the core,
f. fixing the second shell by its inner surface to a second lateral side that is opposite to the first lateral side of the core, and
g. refraining from fixing the first shell directly to the second shell.

38. The method according to claim 18, wherein the step e) is preceded by at least one of the following steps:
the first shell undergoes a surface treatment;
the second shell undergoes a surface treatment.
